(19) United States
(12) Patent Application Publication
(10) Pub. No.: US 2022/0236383 A1
(43) Pub. Date: Jul. 28, 2022

(54) MICRO-ELECTRO-MECHANICAL SYSTEM (MEMS) MICRO-MIRROR ARRAY (MMA) STEERED ACTIVE SITUATIONAL AWARENESS SENSOR

(71) Applicant: Raytheon Company, Waltham, MA (US)

(72) Inventors: Gerald P. Uyeno, Tucson, AZ (US); Sean D. Keller, Tucson, AZ (US); Benn H. Gleason, Tucson, AZ (US)

(21) Appl. No.: 17/159,967

(22) Filed: Jan. 27, 2021

(51) Int. Cl. G01S 7/481; G02B 26/08; G02B 26/10; G01S 17/06

(52) U.S. Cl. CPC G01S 7/4817; G01S 17/06; G02B 26/101; G02B 26/0833

(57) ABSTRACT

An active situational sensor uses a Micro-Electro-Mechanical System (MEMS) Micro-Mirror Array (MMA) in which the mirrors approximate an off-axis section of a parabolic surface, an “OAP”, to re-direct and focus optical radiation onto a conical shape of a fixed mirror oriented along an optical axis. The mirrors tip, tilt and piston to further focus and steer the spot-beam around the conical shape of the fixed mirror, which redirects the spot-beam to scan a FOR. The sensor may rapidly scan a 360° horizontal FOR with a specified vertical FOR or any portion thereof, jump discretely between multiple specific objects per frame, vary the dwell time on an object or compensate for other external factors to tailor the scan to a particular application or changing real-time conditions. The MEMS MMA being configurable to shape the spot-beam to adjust size, focus or intensity profile or to produce deviations in the wavefront of the spot-beam to compensate for path length differences or atmospheric distortion. The MEMS MMA being configurable to produce and independently steer a plurality of spot-beams of the same or different wavelengths.

### BACKGROUND OF THE INVENTION

### Field of the Invention

This invention relates to situational awareness sensors, and more particularly to the use of a Micro-Electro-Mechanical System (MEMS) Micro-Mirror Array (MMA) to steer a laser spot-beam over a sensor field-of-regard (FOR).

### Description of the Related Art

Situational awareness is the perception of environmental elements with respect to time or space, the comprehension of their meaning, and the projection of their status after some variable has changed, such as time, or some other variable, such as a predetermined event. Situational awareness is critical in complex, dynamic systems such as aviation, air traffic control, ship navigation, collision avoidance, object targeting etc.

Situational awareness sensors may be passive or active. Passive sensors use a detector and ambient energy to detect and track objects in the sensor's FOR. Active sensors use a laser to illuminate objects in the FOR and a detector to detect reflected energy. The active sensor may be configured to produce an intensity image or a range map of the illuminated object. Active sensors have the advantages of illuminating a target with a laser and being able to provide range information. However, lasers can be large and expensive and raise the overall “SWaP-C” (size, weight, power and cost) of the sensor.

One type of active sensor uses flash illumination to simultaneously illuminate the entire FOR and a pixelated detector to detect reflected energy. This approach requires a laser with a lot of power, hence size, weight and cost, to provide the requisite energy density over the FOR to detect objects at typical distances. Flash illumination also produces atmospheric backscatter that reduces the signal-to-noise ratio (SNR) of the detected objects. Flash illumination does have the benefit of no moving parts.

Another type of active sensor uses a single laser to generate a collimated spot-beam. A mirror is physically rotated to scan the collimated spot-beam over a 360 degree horizontal FOR. The entire sensor may be actuated up and down to scan a desired vertical FOR. A single detector senses a reflected component of the spot-beam. This approach can use a less powerful laser and avoids atmospheric backscattering but is mechanically scanned.

Velodyne Lidar offers a suite of LIDAR sensors that provide a 360 degree horizontal FOR and a 30-40 degree vertical FOR for real-time autonomous navigation, 3D mobile mapping and other LIDAR applications (U.S. Pat. Nos. 7,969,558 and 8,767,190). The LIDAR sensor includes a base, a housing, a plurality of photon transmitters and photon detectors contained within the housing, a rotary motor that rotates the housing about the base, and a communication component that allows transmission of signals generated by the photon detectors to external components. The photon transmitters and detectors of each pair are held in a fixed relationship with each other. The rotary component includes a rotary power coupling configured to provide power from an external source to the rotary motor, the photon transmitters, and the photon detectors. This approach uses many small emitter/detector pairs but requires mechanical rotation to scan the horizontal FOR.

U.S. Pat. No. 9,927,515 entitled “Liquid Crystal Waveguide Steered Active Situational Awareness Sensor” discloses the use of a liquid crystal waveguide to steer a spot-beam onto a conical shape of a fixed mirror, which redirects the spot-beam to scan a FOR. The sensor may rapidly scan a 360° horizontal FOR with a specified vertical FOR or any portion thereof, jump discretely between multiple specific objects per frame, vary the dwell time on an object or compensate for other external factors to tailor the scan to a particular application or changing real-time conditions.

### SUMMARY OF THE INVENTION

The following is a summary of the invention in order to provide a basic understanding of some aspects of the invention. This summary is not intended to identify key or critical elements of the invention or to delineate the scope of the invention. Its sole purpose is to present some concepts of the invention in a simplified form as a prelude to the more detailed description and the defining claims that are presented later.

The present invention provides an active situational awareness sensor that achieves SWaP-C and SNR improvements by scanning a spot-beam with no moving parts. The sensor may be positioned in any horizontal or vertical direction and may rapidly scan a 360° horizontal FOR in the plane (XY) perpendicular to the axis (Z) of the sensor with a specified vertical FOR perpendicular to the plane of the scan. The sensor may also scan any portion of the FOR, jump between multiple discrete objects per frame, vary the dwell time on an object or compensate for other external factors to tailor the scan to a particular application or changing real-time conditions. The sensor can be easily configured to address different wavelength bands without having to re-design the sensor material system or to recalibrate the steering commands. The sensor can generate, focus and independently steer one or more spot-beams spanning a diversity of wavelengths. The sensor can further shape the one or more spot-beams to adjust spot size, divergence/convergence, intensity profile, optical power, perform wavefront correction or maintain a zero phase difference across the beam.

In an embodiment, a situational awareness sensor comprises a laser (CW or pulsed) configured to generate a beam of optical radiation, a MEMS MMA that, responsive to command signals from a controller, re-directs the optical radiation to focus and steer a spot-beam about an optical axis in the Z direction, a fixed mirror having a conical shape oriented along the optical axis that redirects the spot-beam to scan a field-of-regard (FOR) in the XY plane around the optical axis, and a detector configured to sense a reflected component of the spot-beam. The MEMS MMA is configured to receive the beam at an angle of incidence. The MEMS MMA's mirrors approximate an off-axis section of a parabolic surface, known as an off-axis parabola “OAP”, to re-direct and focus the optical radiation into a spot-beam on the conical shape of the fixed mirror. The mirrors tip, tilt and piston to provide additional focus of the spot-beam and to steer the spot-beam about the optical axis on the conical shape of the fixed mirror to scan the FOR.

In one embodiment, each mirror rotates about X and Y axes, and translates along a Z axis orthogonal to the XY plane to tip, tilt and piston. In an implementation of the MEMS MMA, each mirror is supported at three vertices of an equilateral triangle. Lines defined by three different pairs of the vertices provide three axes at 60 degrees to one another in the XY plane, wherein each said mirror pivots about each said axes to produce tilt, tip and piston in the XYZ space.

In different embodiments, the section of the parabolic surface may be provided by either tipping, tilting and pistoning of the mirrors on a flat substrate or by forming the substrate with a shape that approximates the section of the parabolic surface. The later including either a single curved substrate or multiple flat substrates the form a piecewise linear approximation of the parabolic surface. The forming approach being easier to fabricate but utilizes some of the dynamic range of tip, tilt and piston.

In different embodiments, to focus the optical radiation into the spot-beam, the MEMS MMA may piston the mirrors to make small focus adjustments or tip, tilt and piston the mirrors to add optical power to the section of the parabola to make larger focus adjustments.

In different embodiments, to steer the spot-beam the MEMS MMA may tip, tilt and piston the mirrors to either move the focus of the parabolic surface or rotate the parabolic surface about a fixed focus to approximate a different off-axis section (OAP) of the parabolic surface.

In an embodiment, the MEMS MMA steers the spot-beam to a location Theta X and Theta Y from the optical axis onto the fixed mirror. Theta X is the angle between the projection of the instantaneous location of the axis of the spot-beam on the X-Z plane and the Z-axis and Theta Y is the angle between the instantaneous location of the axis of the spot-beam on the Y-Z and the Z-axis. Theta Z is the angle between the projection of the instantaneous location of the axis of the steered spot-beam and the Z axis. The conical shape of the fixed mirror redirects the spot-beam to a location Phi and Theta Z′ where Phi is the angle between the projection of the instantaneous location of the axis of the redirected spot-beam on the X-Y plane and the X-axis and Theta Z′ is the angle between the projection of the instantaneous location of the axis of the redirected spot-beam on the Z-axis. Theta Z′ is greater than Theta Z. The redirected spot-beam scans a field-of-regard (FOR) defined by the values of Phi and Theta Z′.

In different embodiments, the sensor may include different combinations of optical components L2 and L3. Optic L2 is configured to collimate the redirected spot-beam. Optic L3 is configured to direct the collimated redirected spot-beam through a discrete aperture. In an embodiment, N optical channels are spaced every 360/N degrees around the circumference of the conical shape. Each channel includes an Optic L2 and Optic L3 that guide the redirected spot-beam through a discrete aperture in a support member to scan 360/N degrees of the FOR

The fixed mirror has a “conical shape”, which is defined as “of, relating to, or shaped like a cone.” A cone is defined as an axis perpendicular to a circular base, an apex located on the axis, and a surface that is the locus of straight lines from the apex to the perimeter of the circular base (C1). In different embodiments, the conical shape of the fixed mirror may be a cone (C1), a normal cone (CN1) in which the axis intersects the base in the center of the circle and the surface is rotationally symmetric about the axis, a piecewise linear (PWL) approximation of a cone C1 or CN1, a cone plus a powered optic (C2). PWL of a cone C1 or CN1 plus a powered optic (P2), a truncated cone (C3), a truncated PWL approximation of a cone (P3), a truncated cone plus a powered optic (C4), and a truncated PWL approximation of a cone plus a powered optic (P4). Any of the above conical shapes can be combined to create an acceptable conical shape for the fixed mirror (i.e. a polygon base with a curved surface formed by the locus of curved lines from the apex to the perimeter of the polygon base).

In an embodiment, the conical shape of the fixed mirror includes a curvature to expand the FOR along the optical axis e.g. in Theta Z′. This curvature also adds optical power. The MEMS MMA may be configured to tip, tilt and piston the mirrors to add optical power to the spot-beam to offset the optical power provided by the curvature.

In an embodiment, the piston capability can be used to further shape the spot-beam to adjust size, intensity profile or to produce deviations in the wavefront of the spot-beam to compensate for path length differences or atmospheric distortion.

In an embodiment, the controller issues command signals to steer the spot-beam in a circle around the conical shape and to vary the radius of the circle to move around the conical shape along the optical axis to scan a 360-degree region in Phi and a defined FOR in the X-Y plane (i.e., Theta Z′). If the conical shape is configured to reflect the spot-beam perpendicular to the optical axis, the beam scans a 360-degree horizontal FOR and a defined vertical FOR.

In an embodiment, the controller issues command signals to steer the spot-beam to discrete Theta X, Theta Y to cause the redirected spot-beam to jump between multiple objects in the FOR. The response time of the MEMS MMA allows multiple objects to be illuminated per frame. The controller may issue the command signals to vary the dwell times on different objects. Furthermore, the MEMS MMA can be partitioned into segments to independently steer a plurality of spot-beams to simultaneously illuminate multiple objects

In an embodiment, the controller issues command signals in an acquisition mode to scan a defined FOR to acquire objects and then issues command signals to move the spot-beam discretely from one object to the next to track the objects, suitably multiple objects per frame. The objects do not need to be tracked in sequential order, but can instead be tracked according to priority determined by the controller. Alternately, the MEMS MMA can be configured to scan a single beam in acquisition mode and then be partitioned to scan multiples spot-beams to simultaneously track multiple objects while the main scan is ongoing.

In an embodiment, the controller is responsive to an external signal to remove the effects of that signal to maintain the scan of a specified FOR or object.

These and other features and advantages of the invention will be apparent to those skilled in the art from the following detailed description of preferred embodiments, taken together with the accompanying drawings, in which:

### BRIEF DESCRIPTION OF THE DRAWINGS

FIG. 1 is a diagram of an unmanned ground vehicle (UGV) provided with a MEMS MMA steered situational awareness sensor of the present invention;

FIGS. 2A-2D are top, side, and section views of an embodiment of a MEMS MMA steered situational awareness sensor:

FIG. 3 is a diagram of another embodiment of a MEMS MMA steered situational awareness sensor including optics L2 and L3 for scanning the redirected spot-beam through discrete apertures;

FIGS. 4A-4D are top, side, and section views of the situational awareness sensor of FIG. 3;

FIGS. 5A-5B are illustrations of a known embodiment of a Tip/Tilt/Piston (“TTP”) MEMS MMA and a single mirror actuated to tip, tilt and piston;

FIGS. 6A-6C are illustrations of a MEMS MMA in which the mirrors approximate an off-axis section of a parabolic surface to re-direct and focus incident optical radiation onto the conical shape of a fixed mirror;

FIGS. 7A-7C illustrate beam steering by changing the focus of the parabolic surface;

FIG. 8 illustrates beam steering by rotating the parabolic surface about its focus;

FIG. 9 is an illustration of using the piston capability to make small deviations from the parabolic section to compensate for atmospheric distortion; and

FIGS. 10A-10C are illustrations of partitioning the MEMS MMA into multiple segments to form, focus and steer multiple spot-beams onto the conical surface of the fixed mirror.

### DETAILED DESCRIPTION OF THE INVENTION

The present invention provides an active situational sensor that forms and scans a spot-beam with a Micro-Electro-Mechanical System (MEMS) Micro-Mirror Array (MMA). The sensor may rapidly scan a 360° horizontal FOR with a specified vertical FOR or any portion thereof, jump discretely between multiple specific objects per frame, vary the dwell time on an object or compensate for other external factors to tailor the scan to a particular application or changing real-time conditions. The axis of the sensor may be positioned in any horizontal or vertical direction and the sensor may rapidly scan a 360° FOR in the plane perpendicular to the axis of the sensor with a specified vertical FOR perpendicular to the plane of the scan. The plane perpendicular to the axis of the sensor is referred to as the “horizontal plane” in the remainder of this document, however, this plane does not have to be oriented horizontal (perpendicular to the direction of gravity), for the sensor to function. The sensor can be easily configured to address different wavelength bands without having to re-design the sensor material system or to recalibrate the steering commands. The sensor can generate, focus and independently steer one or more spot-beams spanning a diversity of wavelengths. The sensor can further shape the one or more spot-beams to adjust spot size, divergence/convergence, intensity profile, optical power, perform wavefront correction or maintain a zero phase difference across the beam. The sensor can be used to provide object intensity or ranging in complex, dynamic systems such as aviation, air traffic control, ship navigation, unmanned ground vehicles, collision avoidance, object targeting etc.

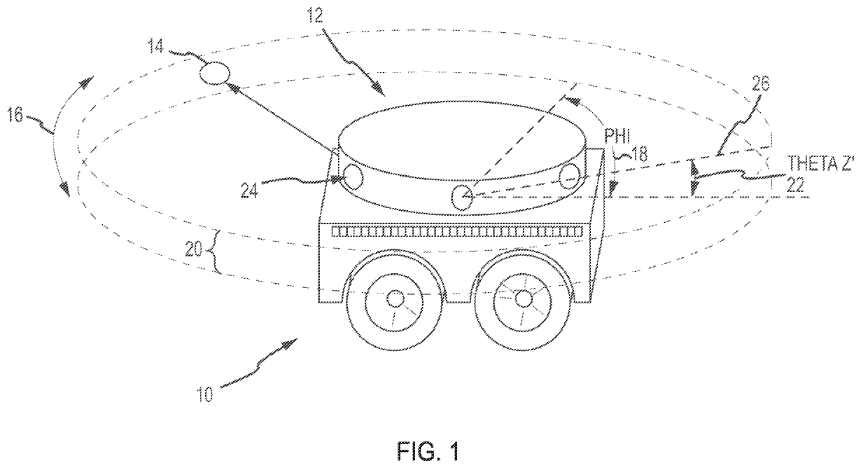

Referring now to FIG. 1, in an embodiment an unmanned ground vehicle (UGV) 10 is outfitted with an active situational awareness sensor 12. Sensor 12 is capable of scanning a spot-beam 14 over a 360° FOR 16 in angle Phi 18 and a defined FOR 20 in angle Theta Z′ 22, typically 2 to 20 degrees. In a specific configuration, the FORs in angle Phi 18 and Theta Z′ 22 correspond to horizontal and vertical FOR, respectively. In other embodiments, sensor 12 may be configured to scan a reduced FOR. For example, in some applications the sensor may need to only scan a forward 180° FOR. More simply, the sensor scans the spot-beam around the Z axis to scan a FOR (e.g. forward 180° or 360°) in the XY plane.

Sensor 12 comprises a laser, a Micro-Electro-Mechanical System (MEMS) Micro-Mirror Array (MMA), a fixed mirror, a controller, a computer, various optical components and a detector housed in a structural housing 24. One or more apertures 26 are formed in housing 24 to facilitate scanning spot-beam 14 over the FOR. To scan the 360° FOR 16, the housing may have a single continuous ring aperture or multiple discrete apertures placed every 360/N degrees.

The laser (CW or pulsed) is configured to generate a beam of optical radiation, which is either directly incident upon or folded onto the MEMS MMA. The MEMS MMA is oriented to nominally re-direct the beam along an optical axis in the Z direction and is responsive to command signals from the controller to focus the optical radiation to steer spot-beam 14 about the optical axis in two dimensions on the surface of the fixed mirror. The fixed mirror has a conical shape oriented along the optical axis and redirects the spot-beam 14 to a location Phi and Theta Z′ in the FOR. The various optical components are configured, at least in part, based on the particular aperture configuration of the sensor to scan the spot-beam 14 over the FOR. The detector is configured to sense a reflected component of the spot-beam, which can be processed to provide intensity or range.

The combination of the MEMS MMA and fixed mirror having a conical shape to focus and steer and redirect a laser spot-beam provides many advantages over known active situational awareness sensors. The SWaP-C benefits of using a single laser to produce a spot-beam over a 360 degree FOR without rotary scanning systems are considerable. The use of a scanned spot-beam significantly reduces atmospheric backscatter, thus improving SNR. Whereas the rotary scanned sensors are limited to continuously scanning the same 360° horizontal FOR over and over, the MEMS MMA steered sensor may rapidly scan a 360° horizontal FOR with a specified vertical FOR or any portion thereof, jump discretely between multiple specific objects per frame, vary the dwell time on an object or compensate for other external factors to tailor the scan to a particular application or changing real-time conditions.

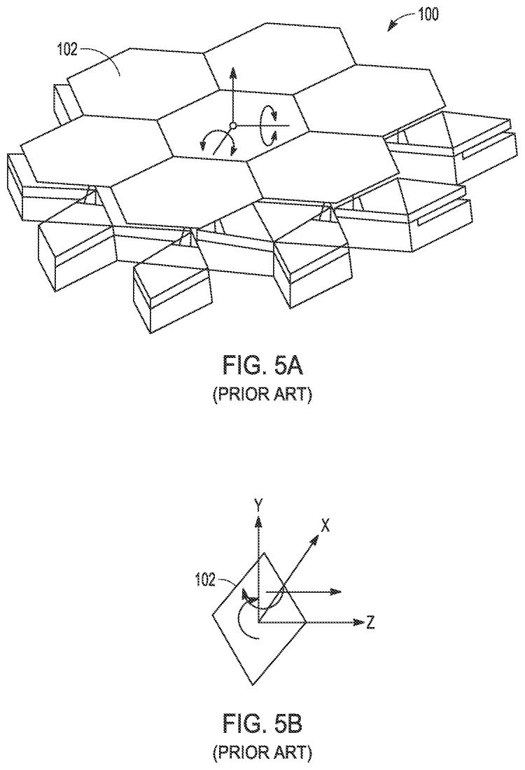

As best shown in FIGS. 5A-5B, a Micro-Electro-Mechanical System (MEMS) Micro-Mirror Array (MMA) 100 comprises a plurality of independently and continuously controllable mirrors 102 to re-direct optical radiation to focus and steer the optical beam(s). Each mirror is capable of at least “Tip” (rotation about an X-axis), “Tilt” (rotation about a Y-axis and “Piston” (translation along a Z-axis, perpendicular to the XY plane) where the X, Y and Z are orthogonal axes in a three-dimensional space. The Piston capability can be used generically speaking to “shape” the beam(s) that are reflected off of the MEMS MMA.

More specifically, in a reflective mode configuration it is important that the MEMS MMA re-directs and focuses the incident optical radiation into a small spot-beam on the conical shape of the fixed mirror consistently over the scanned FOR. As will be described later, this is accomplished with mirrors that approximate an off-axis section (an “OAP”) of a parabolic surface. This may be achieved either via tip, tilt and piston or with a substrate(s) that has a shape that approximates the section of the parabolic surface. The later approach is more difficult to fabricate but preserves the dynamic range of the mirrors for other focusing and beam-steering tasks.

The piston capability can also be used to perform other beam shaping functions such as to adjust the size, divergence or intensity profile of the spot-beam, produce deviations in the wavefront of the beam to compensate for atmospheric distortions, adjust phase to maintain a zero phase difference across the beam, add optical power to the beam or to improve the formation and steering of the beam by approximating a continuous surface across the micro-mirrors, which reduces unwanted diffraction to increase power in the f optical beam.

The MEMS MMA is preferably capable of steering a spot-beam over a range of at least −15° x+15° in tip and tilt (30°×30° and steering range) and +/−15 microns (at least one-half wavelength in either direction) piston at a rate of at least 1 KHz (<1 millisecond). The independently controllable mirrors can be adaptively segmented to form any number of spot-beams, adjust the size/power of a given spot-beam, generate multi-spectral optical beams and to combine multiple input sources. Further, the MEMS MMA must have a sufficient number of mirrors, mirror size/resolution, fill factor, range of motion, response time, response accuracy and uniformity across the array.

One such MEMS MMA is described in U.S. Pat. No. 10,444,492 entitled “Flexure-Based, Tip-Tilt-Piston Actuation Micro-Array”, which is hereby incorporated by reference. As shown in FIGS. 1-3 of the '492 patent this MEMS MMA uses flexures to support each mirror at three fulcrum points (or vertices) of an equilateral triangle. The three different pairs of fulcrum points define three axes at 60 degrees to one another in the XY plane. Each mirror pivots about each axis to produce tip, tilt and piston in the XYZ space. This MEMS MMA is currently being commercialized by Bright Silicon technologies for “digitally controlling light.”

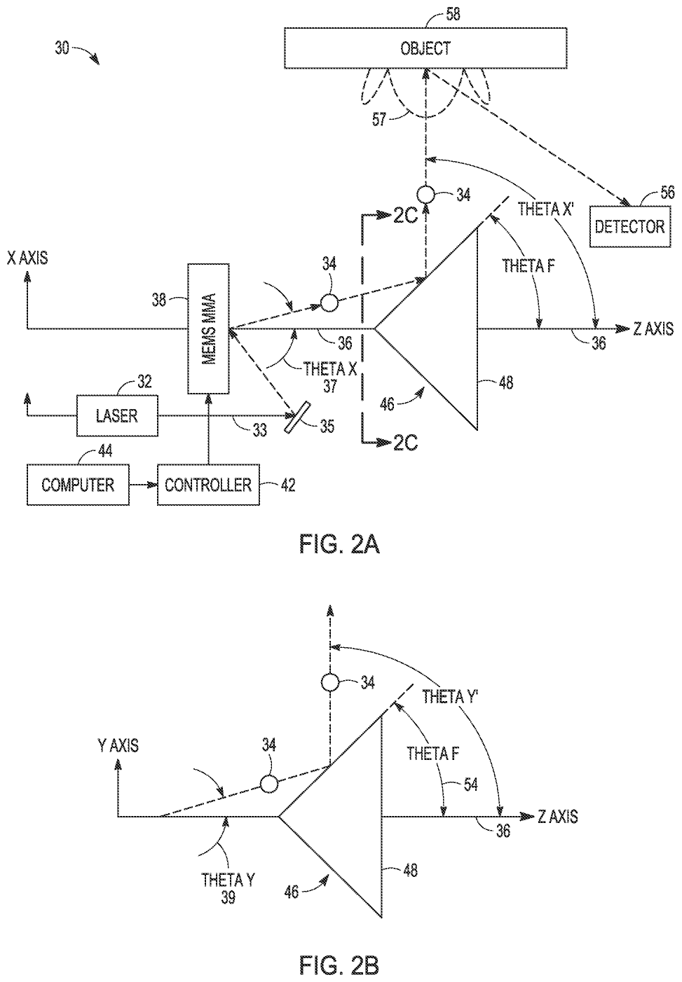

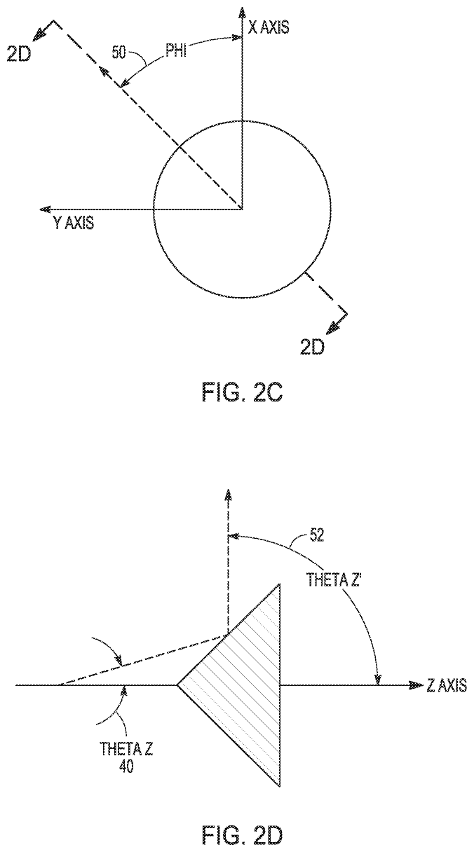

Referring now to FIGS. 2A through 2D, an embodiment of an active situational awareness sensor 30 comprises a laser 32 configured to generate a beam 33 of optical radiation. A fold mirror 35 re-directs beam 33 onto a MEMS MMA 38 at an angle of incidence. In an alternate embodiment, beam 33 may be directed onto MEMS MMA 38 without a fold mirror. MEMS MMA 38 is oriented to nominally re-direct optical radiation along an optical axis 36 in the Z direction and is responsive to command signals to focus the optical radiation to form and steer a spot-beam 34 about the optical axis to a location Theta X 37 and Theta Y 39 from the optical axis where Theta X is the angle between the projection of the instantaneous location of the axis of the spot-beam on the X-Z plane and the Z-axis and Theta Y is the angle between the instantaneous location of the axis of the spot-beam on the Y-Z plane and the Z-axis. Theta Z 40 is the angle between the projection of the instantaneous location of the axis of the steered spot-beam and the Z-axis.

Because of the rotational symmetry, the position of the X-axis is, more or less, arbitrary. In this description. X is parallel to the “in plane” steering direction of the waveguide and Y is parallel to the “out of plane” steering direction of the waveguide. Making X parallel to the in plane steering direction of the waveguide simplifies the description, but it does not have to be in this location, there is a straightforward transform to relate any choice of X to the in plane steering direction.

A controller 42 is configured to issue command signals to the MEMS MMA 38 to steer the spot-beam 34 to the desired Theta X and Theta Y. A computer 44 is configured to issue signals to the controller 42 that provide the desired Theta X and Theta Y to implement a continuous scan, illumination of multiple discrete objects, variable dwell time, compensation for an external signal etc.

A fixed mirror 46 has a conical shape 48 oriented along the optical axis 36 (coincident with or offset from in different configurations) to redirect the spot-beam 34 to a location Phi 50 and Theta Z′ 52 where Phi is the angle between the projection of the instantaneous location of the axis of the redirected spot-beam on the X-Y plane and the X-axis and Theta Z′ is the angle between the projection of the instantaneous location of the axis of the redirected spot-beam and the Z-axis. Theta Z′ 52 is greater than Theta Z 40. The redirected spot-beam 34 scans a FOR defined by the values of Phi and Theta Z′. Theta X′ is the angle between the projection of the instantaneous location of the axis of the redirected spot-beam on the X-Y plane and the Z-axis and Theta Y′ is the angle between the instantaneous location of the axis of the redirected and the Z-axis.

Steering spot-beam 34 in a circle (i.e. a constant Theta Z) around the conical shape scans the redirected spot-beam 34 around a 360° FOR in Phi. Varying the radius of the circle (i.e. changing the constant value of Theta Z) scans the redirected spot-beam 34 in a defined FOR in Theta Z′. The angle Theta F 54 of the conical shape 48 of fixed mirror 46 may or may not be configured such that the spot-beam 34 is redirected perpendicular to optical axis 36. When Theta F produces a Theta Z′ perpendicular to the Z-axis, the situational awareness sensor has a two-dimensional band of coverage comprised of Phi and Theta Z′ that is centered on the Z axis along with the fixed mirror 46. Increasing or decreasing Theta F increases or decreases the nominal Theta Z′, respectively. This shifts the two-dimensional band of coverage comprised of Phi and Theta Z′ along the Z axis.

The ability to control the redirection of the spot-beam allows the total FOR of the sensor to be optimized. For example, if the FOR is a volume on top of a flat surface the sensor can be placed near the surface and the spot-beam directed perpendicular to the optical axis to maximize the volume of the FOR. In a second example, if the FOR is a circularly shaped region (perimeter) on top of a flat surface, the sensor can be placed above the ground and the spot-beam directed down to scan the circularly shaped region of interest. In a third example, if the sensor is in the front of a moving vehicle, the sensor axis can be directed in the forward direction and the spot-beam directed up to scan the volume in front of the moving vehicle to detect objects in front of the vehicle.

A detector 56 is configured to sense a reflected component 57 of the spot-beam reflected from an object 58. The reflected component may be processed to provide an intensity of the illuminated object or a range to the illuminated object.

The fixed mirror 46 has a “conical shape” 48, which is defined as “of, relating to, or shaped like a cone.” A cone is a three dimensional geometric shape described by a circular base, an axis perpendicular to a circular base, an apex located on the axis, and a surface that is the locus of straight lines from the apex to the perimeter of the circular base (C1). A “normal” cone (CN1) is a cone in which the axis intersects the base in the center of the circle and the surface is rotationally symmetric about the axis.

A piecewise linear approximation (P1) of a cone (C1 or CN1) is three dimensional geometric shape described by a base that is a polygon with 3 or more sides, an axis perpendicular to the base, an apex located on the axis and a surface that is the locus of straight lines from the apex to perimeter of the base. If the axis is located at the center of the polygon, the geometric shape is rotationally symmetric about the axis.

A cone (C1 or CN1) plus a powered optic (C2) is a three dimensional geometric shape described by a circular base, an axis perpendicular to the base, an apex located on the axis and a surface that is the locus of lines that curve in planes that are parallel to the axis from the apex to perimeter of the base. Because the mirror's surface is curved, the spot size is actually different at different locations on the mirror. This causes some distortions in the far field and extra beam divergence. Using an aspherical surface helps correct this. The effect is reduced with more apertures.

The curvature of the cone can be constructed such that the surface normal of the cone changes to enable a larger FOR along the Z-axis in Theta Z′. The curvature across the cone adds optical power to the beam, but because the beam is focused to a spot on the cone the effects of power are dwarfed by the change in angle of incidence. This enables the spot-beam to be directed to a larger Theta Z′ FOR. Using the tip, tilt and piston capability of the MEMS MMA, this added power can be “canceled out” with an opposite optical power.

A PWL approximation of a cone (C1 or CN1) plus a powered optic (P2) is a three dimensional geometric shape described by a base that is a polygon with 3 or more sides, an axis perpendicular to the base, an apex located on the axis and a surface that is the locus of lines that curve in planes that are parallel to the axis from the apex to perimeter of the base.

A truncated cone (C3) is a three dimensional geometric shape described by a circular base, an axis perpendicular to the base, a top described by a circle and a surface that is the locus of straight lines parallel to the axis from the perimeter of the top to perimeter of the base.

A truncated PWL approximation of a cone (P3) is a three dimensional geometric shape described by a base that is a polygon with 3 or more sides, an axis perpendicular to the base, a top described by a polygon of 3 or more sides and a surface that is the locus of straight lines from the perimeter of the top to perimeter of the base.

A truncated cone plus a powered optic (C4) is a three dimensional geometric shape described by a circular base, an axis perpendicular to the base that intersects the base in the center of the circle, a top described by a circle and a surface that is the locus of lines that curve in planes that are parallel to the axis from the perimeter of the top to perimeter of the base.

A truncated PWL approximation of a cone plus a powered optic (P4) is a three dimensional geometric shape described by a base that is a polygon with 3 or more sides, an axis perpendicular to the base, a top described by a polygon of 3 or more sides and a surface that is the locus of lines that curve in planes that are parallel to the axis from the perimeter of the top to perimeter of the base.

Any of the above conical shapes can be combined to create an acceptable conical shape for the fixed mirror (i.e. a polygon base with a curved surface formed by the locus of curved lines from the apex to the perimeter of the polygon base).

Any of the above conical shapes are subject to manufacturing tolerances of the fixed mirror. A conical shape, such as a normal cone, that is designed to be rotationally symmetric about the axis may deviate from such symmetry within the manufacturing tolerances. Alternately, a conical shape may be designed with the axis intentionally offset from the center of the base (circle or polygon) in order to scan a particular FOR. Another alternative is to use the MEMS MMA to vary Theta Z as a function of Phi in order to scan a particular FOR with any conical shape.

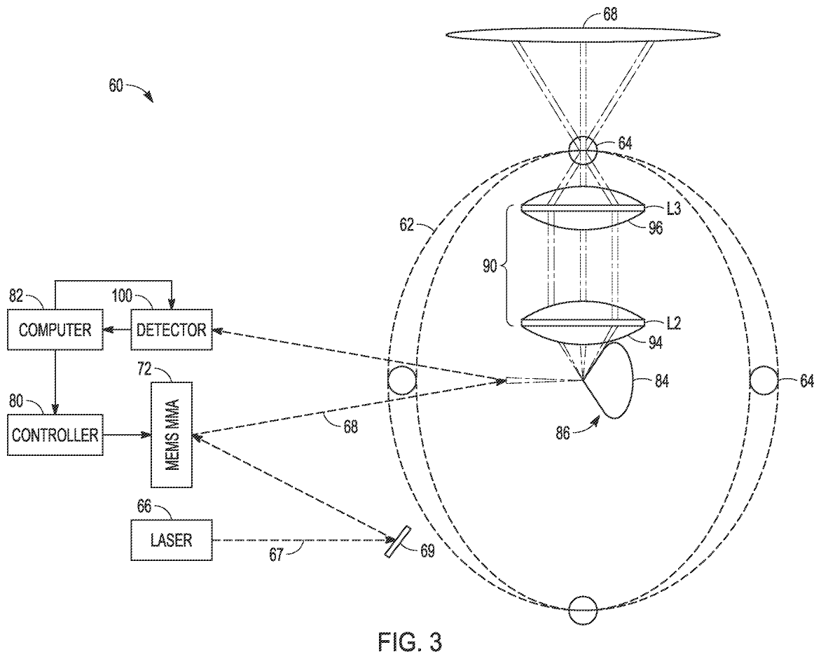

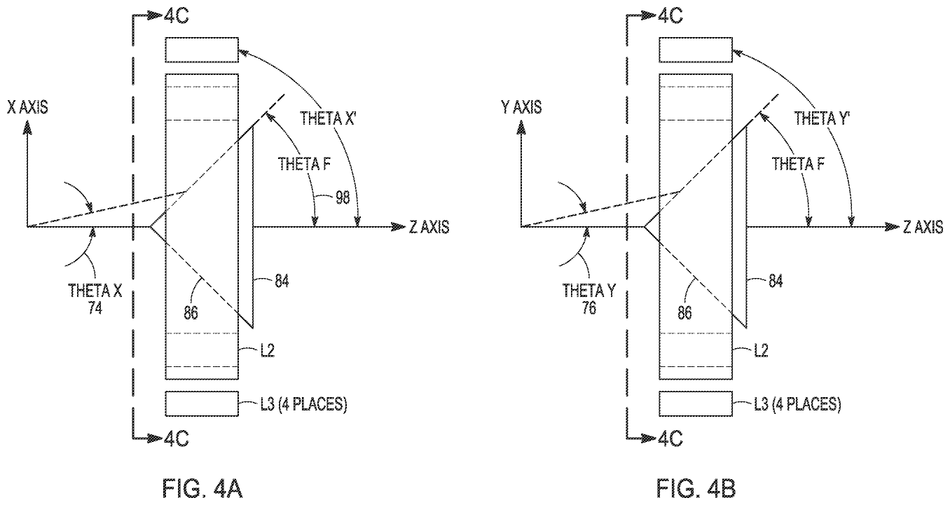

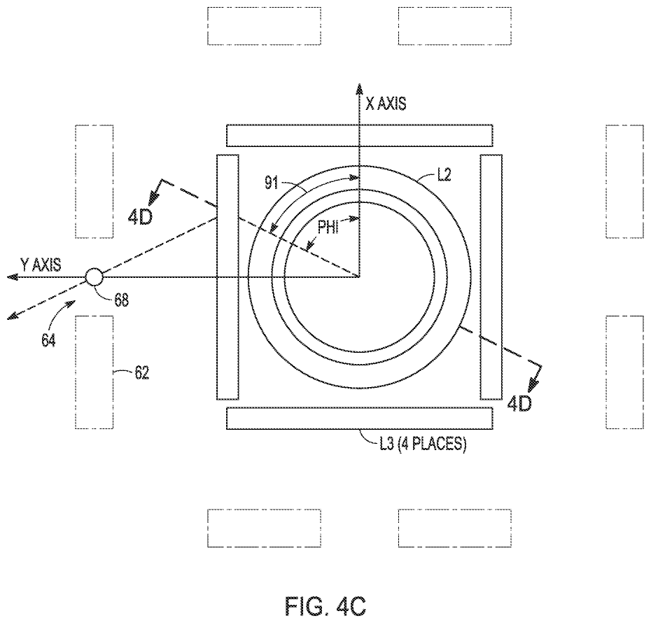

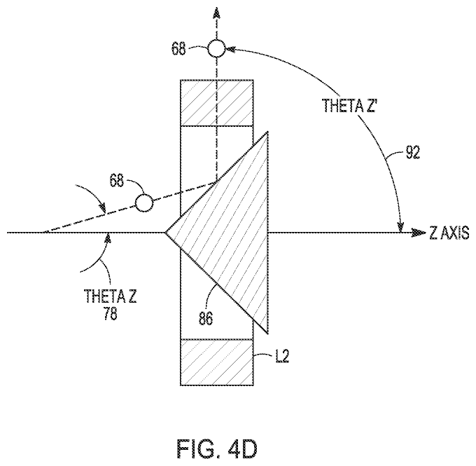

Referring now to FIGS. 3 and 4A through 4D, an embodiment of an active situational awareness sensor 60 comprises a housing 62 having four discrete apertures 64 formed about its circumference at 90° (360°/4) intervals. The housing comprises a structural member configured to provide support primarily in the direction parallel to the sensor axis.

A laser 66 is configured to generate a beam 67 of optical radiation that is redirected off a fold mirror 69 onto a MEMS MMA 72 at an angle of incidence. MEMS MMA 72 is oriented to nominally re-direct optical radiation along an optical axis 70 that is oriented in the Z direction. MEMS MMA 72 is responsive to command signals to focus and steer a spot-beam 68 about the optical axis to a location Theta X 74 and Theta Y 76 from the optical axis where Theta X is the angle between the projection of the instantaneous location of the axis of the spot-beam on the X-Y plane and the Z-axis and Theta Y is the angle between the instantaneous location of the axis of the spot-beam and the Z-axis such that Theta X is in the plane of the X-axis and Theta Y is in the plane of the Y-axis. Theta Z 78 is the angle between the projection of the instantaneous location of the axis of the steered spot-beam and the Z-axis. Because of the rotational symmetry, the position of the X axis is, more or less, arbitrary.

A controller 80 is configured to issue command signals to the MEMS MMA 72 to steer the spot-beam 68 to the desired Theta X and Theta Y. A computer 82 is configured to issue signals to the controller 80 that provide the desired Theta X and Theta Y to implement a continuous scan, illumination of multiple discrete objects, variable dwell time, compensation for an external signal etc.

A fixed mirror 84 has a conical shape 86 that is oriented along the optical axis 70 in the Z direction. In this particular configuration, conical shape 86 is a normal cone (CN1) that is rotationally symmetric about its axis, which is coincident with the optical axis 70. The tip of the cone is positioned towards the MEMS MMA with the radius of the cone increasing along the axis away from the MEMS MMA. MEMS MMA is suitably configured so that its focus is at the conical shape of the fixed mirror. This creates the minimum spot size on the conical surface. Since the round beam is actually being projected onto a curved surface, there is distortion of the beam due to the mirror's surface. Keeping the spot small makes the spot project on a “localized flat” surface.

Four optical channels 90 are positioned between fixed mirror 84 and a different one of the apertures 64 in the housing 62 to guide the redirected spot-beam 68 through the corresponding aperture 64 to a location Phi 91 and Theta Z′ 92 where Phi is the angle between the projection of the instantaneous location of the axis of the redirected spot-beam on the X-Y plane and the X axis and Theta Z′ is the angle between the projection of the instantaneous location of the axis of redirected spot-beam on the Z axis. Theta Z′ 92 is greater than Theta Z 78. The redirected spot-beam 68 scans a FOR defined by the values of Phi and Theta Z′.

Each optical channel 90 comprises an optic L2 94 and an optic L3 96. Optic L2 is of larger diameter to collect light coming off the mirror at +/−45 degrees (nominally). A smaller optic is achieved using more and smaller apertures. Optic L2 is placed at approximately its focal length from the mirror to collimate the light. Optic L3 is a fast (low F/#, short focal length) lens that quickly causes the light to cross and diverge out of the aperture.

Steering spot-beam 68 in a circle (constant Theta Z) around the conical shape scans the redirected spot-beam 68 from one aperture 64 to the next around a 360° FOR in Phi. Varying the radius of the circle scans the redirected spot-beam 68 in a defined FOR in Theta Z′. The angle Theta F 98 of the conical shape 86 of fixed mirror 84 may or may not be configured such that the spot-beam 64 is redirected perpendicular to optical axis 70.

A detector 100 is configured to sense a reflected component of the spot-beam. The reflected component may be processed to provide an intensity of the illuminated object or a range to the illuminated object.

In order to properly form the spot-beam in a small spot on the conical surface of the fixed mirror so that the shape of spot-beam remains consistent (e.g., avoids asymmetrical stretching/compression) as it scans around the mirror, it is critical that the spot-beam is focused onto the conical mirror. If not properly focused, the larger spot projected onto the conical surface will reflect light into a fan, rather than another spot-beam. In order to do this, the mirrors of the MMA must approximate an off-axis section of a parabolic surface. The mirrors are actuated in tip, tilt and piston to deviate from the off-axis section of the parabolic surface to focus and steer the spot-beam around the conical surface of the fixed mirror based on the laser divergence, element spacing and conical mirror size.

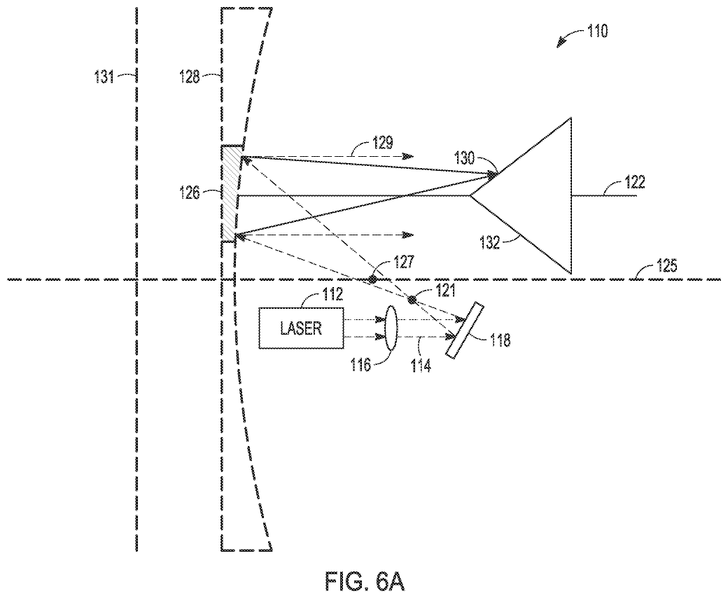

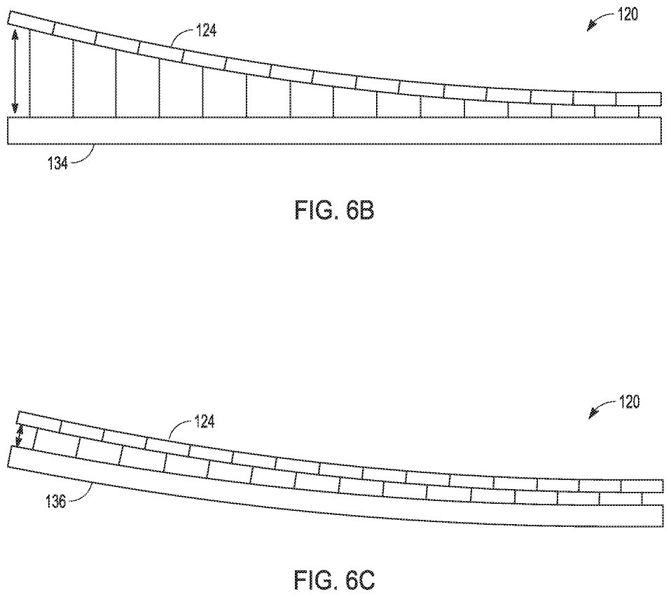

Referring now to FIGS. 6A through 6C, an embodiment of an active situational awareness sensor 110 comprises a laser 112 configured to generate a beam 114 of optical radiation that passes through a lens 116 and is incident on a fold mirror 118. Fold mirror 118 re-directs beam 114 onto a MEMS MMA 120 at an angle of incidence. MEMS MMA 120 is oriented to nominally re-direct optical radiation along an optical axis 122 in the Z direction. In a base or nominal configuration, mirrors 124 provide a curvature that approximates an off-axis section 126 (an “OAP”) of a parabolic surface 128. The OAP re-directs and focuses optical radiation 128 to form a spot-beam 130 on the conical shape of a fixed mirror 132 whose axis is coincident with optical axis 122. The MEMS MMA is responsive to command signals to provide additional focus and to steer spot-beam 130 about the optical axis on the conical surface of the fixed mirror 132. The MEMS MMA may piston the mirrors to provide a small amount of focusing or may tip, tilt and piston the mirrors to add curvature (optical power) to the section of the parabolic surface to provide a larger amount of focusing.

A parabola is defined as a set of points that form a curve where any point on the curve is at an equal distance from a fixed point, the “focus” 127, and a straight line, the “directrix” 131. The focus 127 lies on an axis 125 perpendicular to the directrix 131. The optical axis 122 of fixed mirror 132 is oriented perpendicular to directrix 131. The focus 127 and the specific OAP 126 of the parabola are selected to re-direct and focus optical radiation into a spot at a specified location on the conical shape of fixed mirror 132. In an embodiment, laser 112 is nominally positioned 2 focal lengths away from the OAP 126. Fixed mirror 132 is placed another 2 focal lengths from the OAP. This forms a 2-f focusing system between the laser and fixed mirror. The OAP relays the laser focus 121 onto the conical shape of the fixed. The angles between the laser and fixed mirror determine the specific OAP used to re-direct light toward the optical axis of the fixed mirror. Other optical configurations and specific OAP designs used to focus light into a small spot on the conical shape of the fixed mirror are within the scope of the present invention.

As shown in FIGS. 6B and 6C, the mirrors 124 may approximate the section 126 of the parabolic surface 128 either with a MEMS MMA fabricated on a flat substrate 134 in which the mirrors are tipped, tilted, and pistoned to approximate the section or by fabricating the MEMS MMA on a substrate 136 whose shape approximates the section of the parabola, respectively. The later approach includes either a single curved substrate or multiple flat substrates that form a piecewise linear approximation of the parabolic surface. The later approach being more difficult but preserves the dynamic range of the mirrors in tip, tilt and piston for focusing and steering the spot-beam.

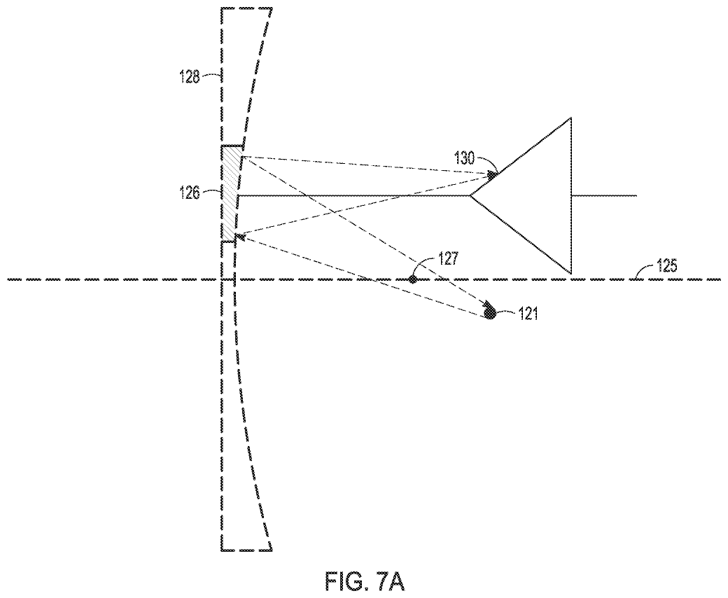

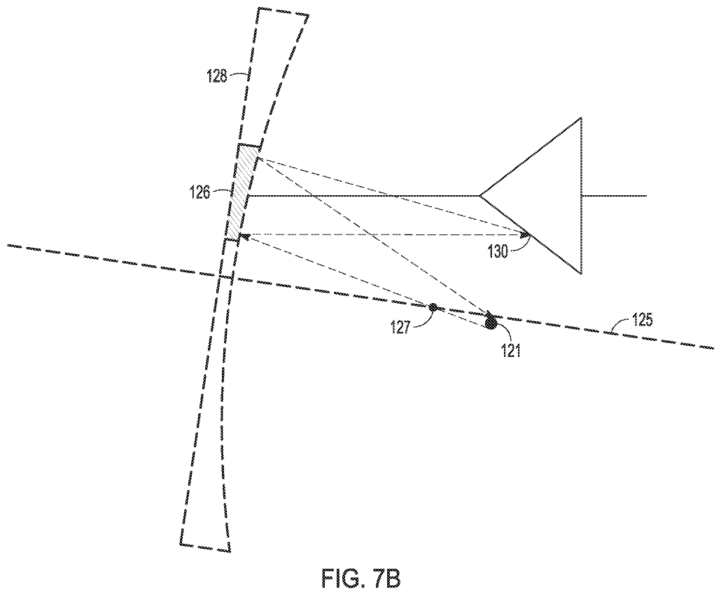

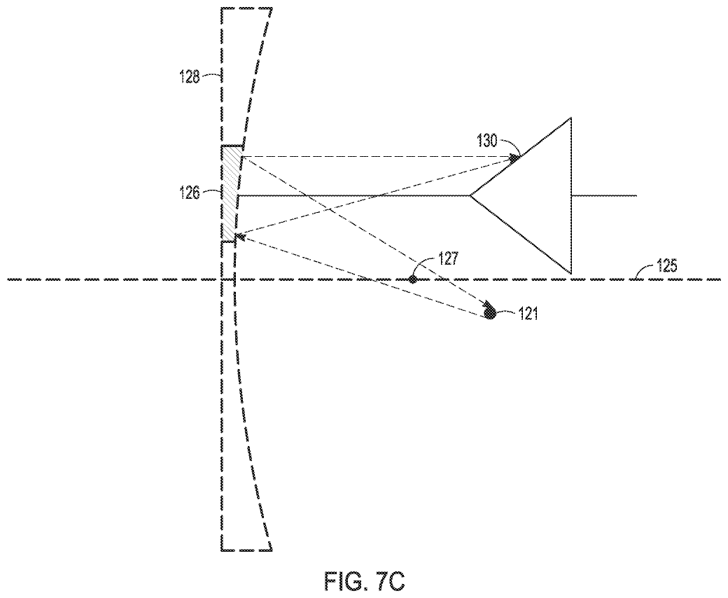

As shown in FIGS. 7A through 7C, the MEMS MMA can tip, tilt and piston the mirrors to move the focus 127 of the parabolic surface 128 to approximate a different off-axis section 126 to steer spot-beam 130 on the conic shape of the fixed mirror. As shown in FIG. 7B, the mirrors are actuated to tilt the parabolic surface to steer the spot-beam 130. As shown in FIG. 7C, the mirrors are translated (pistoned) to translate the parabolic surface to steer the spot-beam 130.

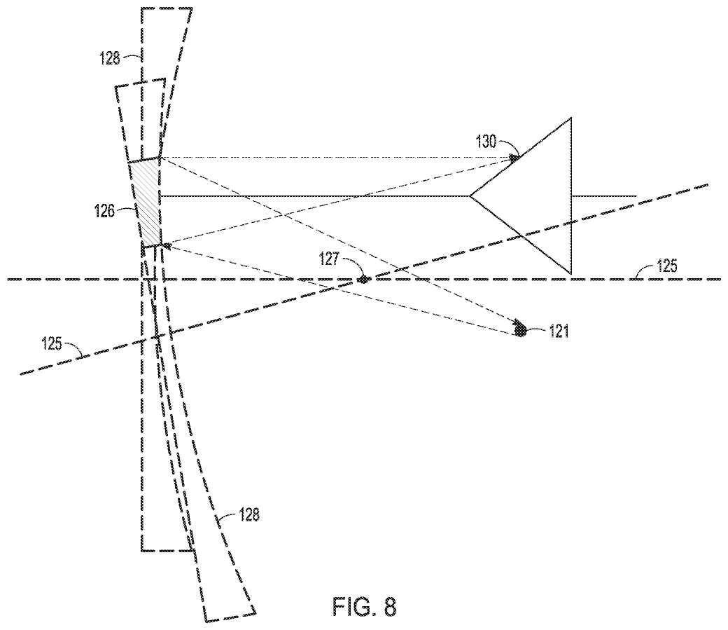

As shown in FIG. 8, the MEMS MMA can tip, tilt and piston the mirrors to rotate the parabolic surface 128 about focus 127 to approximate a different off-axis section 126 of the parabolic surface 128 to steer spot-beam 130.

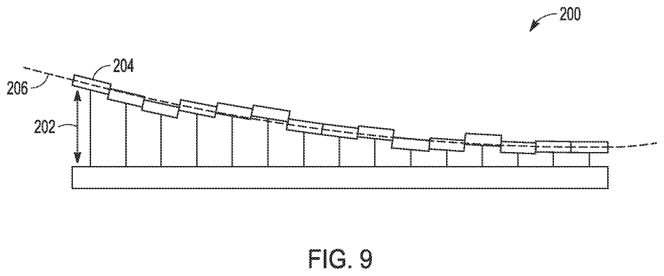

As previously mentioned, the MMA's piston capability can be generally used to “shape” the optical radiation or spot-beam. In addition to focusing and steering the spot-beam, the piston can be used to perform other optical functions on the spot-beam concurrently. As illustrated in FIG. 9, responsive to command signals a MEMS MMA 200 can adjust the piston 202 of mirrors 204 to induce deviations from an off-axis section of a parabolic surface 206. This can be done to compensate for path length variation of the spot-beam (to maintain zero phase across the beam), to correct for atmospheric distortion or both. Adjustments for path length variation can be calibrated offline and stored in a lookup table (LUT) as a function of scan angle. Adjustments for atmospheric distortion are done in real-time during operation of the active imaging system. For wavefront correction, a source emits optical energy in a similar band to illumination e.g., SWIR a beam steerer scans the optical beam onto scene. A wavefront sensor measures the wavefront of the reflected beam to determine the effects of atmospheric distortion. A controller computes the requisite piston adjustments required to correct the wavefront and provides them as command signals to the MEMS MMA. In high quality, high performing active imaging systems, the ability to accurately remove the effects of path length variation and atmospheric distortion is critical to achieving useful imagery of the scene, and important features identified within the scene.

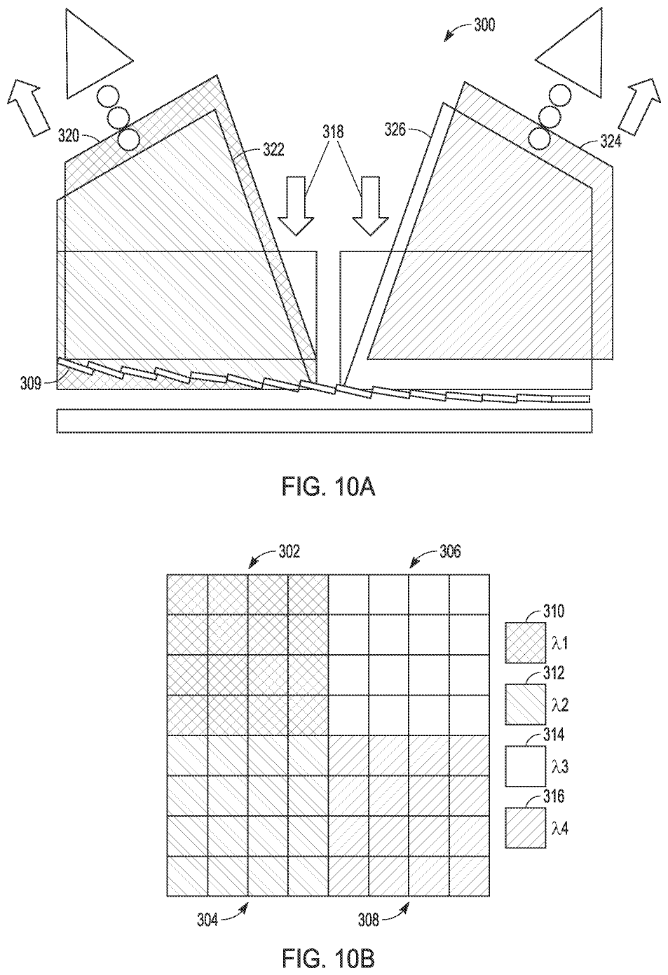

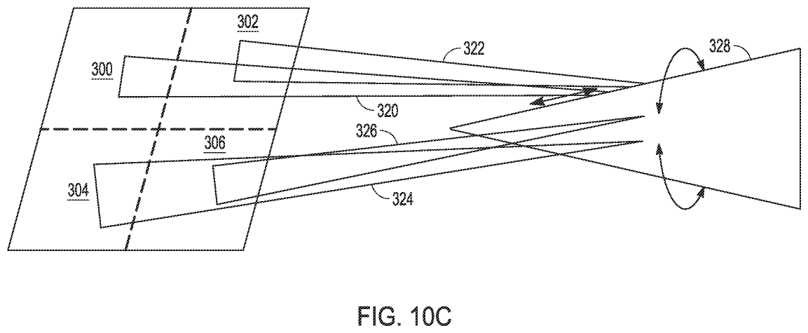

As illustrated in FIGS. 10A-10C, responsive to command signals from the controller, a MEMS MMA 300 is partitioned into four segments 302, 304, 306 and 308 each including a plurality of mirrors 309 illuminated by optical radiation 318. The mirrors in the different sections are provided with reflective coatings 310, 312, 314 and 316 at different wavelengths. The mirrors in 309 approximate different sub-sections of the section of the parabolic surface as previously described. In response to command signals, the MEMS MMA tips/tilts/pistons the mirrors in each segment to independently focus and scan optical beams 320, 322, 324 and 326 over different portions of the conical surface of a fixed mirror 328 to scan different portions of a FOR about the optical axis. In an embodiment, one or more beams are used to scan a repetitive pattern in a 360 degree FOR around the optical axis to detect objects and one or more beams are used to scan the locations of the detected objects while the initial 360 degree scan is ongoing. The scans may contain the same or different wavelength compositions. For example, the repetitive scan could be a broad spectral scan and the location specific scans could be narrow spectral scans.

While several illustrative embodiments of the invention have been shown and described, numerous variations and alternate embodiments will occur to those skilled in the art. Such variations and alternate embodiments are contemplated, and can be made without departing from the spirit and scope of the invention as defined in the appended claims.

We claim:

1. A situational awareness sensor, comprising:
a laser configured to generate a beam of optical radiation;
a fixed mirror having a conical shape oriented along an optical axis;
a Micro-Electro-Mechanical System (MEMS) Micro-Mirror Array (MMA) positioned to receive the beam at an angle of incidence, said MEMS MMA comprising a plurality of independent and continuously controlled mirrors that approximate an off-axis section of a parabolic surface to re-direct and focus the optical radiation into a spot-beam on the conical shape of the fixed mirror, said mirrors responsive to command signals to tip, tilt and piston each mirror in a three-dimensional space to further focus the spot-beam and to steer the spot-beam in two-dimensions about the optical axis to scan a field-of-regard (FOR) around the optical axis;
a controller configured to issue command signals to the MEMS MMA to focus and steer the spot-beam; and
a detector configured to sense a reflected component of the spot-beam.

2. The situational awareness sensor of claim 1, wherein the MEMS MMA includes one or more substrates on which the mirrors are supported, wherein said one or more substrates have a shape that approximates the section of the parabolic surface.

3. The situational awareness sensor of claim 1, wherein the MEMS MMA includes a flat substrate on which the mirrors are supported, wherein responsive to command signals the mirrors tip, tilt and piston to approximate the off-axis section of the parabolic surface.

4. The situational awareness sensor of claim 1, wherein responsive to command signals the mirrors piston to further focus the spot-beam.

5. The situational awareness sensor of claim 1, wherein responsive to command signals the mirrors tip, tilt and piston to add optical power to the section of the parabola to further focus the spot-beam.

6. The situational awareness sensor of claim 1, wherein the MEMS MMA tips, tilts and pistons the mirrors to move a focus of the parabolic surface to steer the spot-beam about the optical axis.

7. The situational awareness sensor of claim 1, wherein the MEMS MMA tips, tilts and pistons the mirrors to rotate the parabolic surface about a focus to approximate a different off-axis section of the parabolic surface to steer spot-beam.

8. The situational awareness sensor of claim 1, wherein the optical axis of the fixed mirror is oriented in a Z direction, wherein the MEMS MMA steers the spot-beam about the optical axis to a location Theta X and Theta Y from the optical axis where Theta X is the angle between the projection of the instantaneous location of the axis of spot-beam on the X-Z plane and the Z axis and Theta Y is the angle between the instantaneous location of the axis of the spot-beam on the Y-Z plane and the Z axis, and Theta Z is the angle between the projection of the instantaneous location of the axis of the steered spot-beam and the Z axis, wherein the fixed mirror redirects the spot-beam to a location Phi and Theta Z′ where Phi is the angle between the projection of the instantaneous location of the axis of the redirected spot-beam on the X-Y plane and the X axis and Theta Z′ is the angle between the projection of the instantaneous location of the axis of the redirected spot-beam on the Z axis and Theta Z′ is greater than Theta Z, wherein the redirected spot-beam scans a field-of-regard (FOR) defined by the values of Phi and Theta Z′.

9. The situational awareness sensor of claim 1, further comprising
a structural member having N discrete apertures formed therein at 360/N degree intervals about the optical axis; and
N transport optic channels placed around the fixed mirror at 360/N degree intervals, each channel comprising an optic L2 configured to collimate the redirected spot-beam beam and an optic L3 configured to direct the collimated redirected spot-beam through the corresponding aperture.

10. The situational awareness sensor of claim 1, wherein the conical shape includes a curvature to expand the FOR along the optical axis and provide optical power, wherein the wherein the MEMS MMA is responsive to command signals to tip, tilt and piston to add optical power to the spot-beam to offset the optical power provided by the curvature.

11. The situational awareness sensor of claim 1, wherein the MEMS MMA is responsive to command signals to tip, tilt and piston to shape the spot-beam to perform one or more of the following:
adjust a size, divergence or intensity profile of the spot-beam;
produce deviations in the wavefront of the spot-beam to compensate for atmospheric distortion; and
adjust the phase and maintain a zero phase difference across the spot-beam.

12. The situational awareness sensor of claim 1, wherein the MEMS MMA is partitioned into a plurality of segments, each segment including a plurality of mirrors, and to tip, tilt and piston the mirrors in each segment to approximate different sub-sections of the off-axis section of the parabolic surface to re-direct and focus the optical radiation into a plurality of spot-beams on the conical shape of the fixed mirror, said MEMS MMA responsive to command signals to tip, tilt and piston the mirrors in each segment to further focus and steer the spot-beams about the optical axis, wherein the conical shape of the fixed mirror redirects the plurality of spot-beams to scan the FOR.

13. The situational awareness sensor of claim 12, wherein the MEMS MMA is responsive to command signals to simultaneously steer the plurality of spot-beams over different portions of the FOR.

14. The situational awareness sensor of claim 12, wherein the MEMS MMA is responsive to command signals to simultaneously steer at least one said spot-beam in a repetitive scan pattern around the optical axis in a 360 degree FOR and at least one said spot-beam in a scan pattern to interrogate an object detected in the 360 degree FOR.

15. The situational awareness sensor of claim 12, wherein the mirrors in each segment reflect light at different wavelengths such that the optical radiation is redirected into the plurality of spot-beams at different wavelengths.

16. The situational awareness sensor of claim 11, wherein the mirrors reflect light at different wavelengths such that the spot-beam includes a plurality of different wavelengths.

17. The situational awareness sensor of claim 1, wherein each said mirror rotates about X and Y orthogonal axes, respectively, and translates in a Y axis orthogonal the XY plane to tip, tilt and piston, respectively.

18. The situational awareness sensor of claim 17, wherein each said mirror is supported at three vertices of a triangle, wherein lines defined by three different pairs of said vertices provide three axes at 60 degrees to one another in the XY plane, wherein each said mirror pivots about each said axes to produce tilt, tip and piston in the XYZ space.

19. The situational awareness sensor of claim 1, wherein the parabolic surface is defined by a directrix and a focus, wherein the optical axis of the fixed mirror is oriented perpendicular to the directrix.

20. A situational awareness sensor, comprising:
a laser configured to generate a beam of optical radiation;
a fixed mirror having a conical shape oriented along an optical axis;
a Micro-Electro-Mechanical System (MEMS) Micro-Mirror Array (MMA) positioned to receive the beam at an angle of incidence, said MEMS MMA comprising a plurality of independent and continuously controlled mirrors, said mirrors responsive to command signals to tip, tilt and piston to approximate an off-axis section of a parabolic surface to re-direct and focus the optical radiation into a spot-beam on the conical shape of the fixed mirror and to steer the spot-beam in two-dimensions about the optical axis on the conical shape of the fixed mirror to scan a field-of-regard (FOR) about the optical axis;
a controller configured to issue command signals to the MEMS MMA to focus and steer the spot-beam; and
a detector configured to sense a reflected component of the spot-beam.

21. A situational awareness sensor, comprising:
a laser configured to generate a beam of optical radiation;
a fixed mirror having a conical shape oriented along an optical axis;
a Micro-Electro-Mechanical System (MEMS) Micro-Mirror Array (MMA) positioned to receive the beam at an angle of incidence, said MEMS MMA responsive to command signals to partition itself into a plurality of segments, each segment including a plurality of mirrors, and to tip, tilt and piston the mirrors in each segment to approximate different sub-sections of an off-axis section of a parabolic surface to re-direct the optical radiation and focus the optical radiation into a plurality of spot-beams on the conical shape of the fixed mirror, said MEMS MMA responsive to command signals to tip, tilt and piston the mirrors in each segment to further focus and steer the plurality of spot-beams about the optical axis on the conical shape of the fixed mirror to scan a field-of-regard (FOR) about the optical axis, wherein the mirrors in different segments reflect light at different wavelengths such that the plurality of optical beams include a diversity of wavelengths;
a controller configured to issue command signals to the MEMS MMA to partition the MEMS MMA into the segments, focus and steer the spot-beams; and
a detector configured to sense a reflected component of the spot-beams.
